(19) United States
(12) Patent Application Publication
(10) Pub. No.: US 2008/0230185 A1
(43) Pub. Date: Sep. 25, 2008

(54) Electric adjustable tension shade bar

(76) Inventor: Russell Kahn, New Rochelle, NY (US)

Correspondence Address: THEODORE JAY, SUITE 600, 16 N CHATSWORTH AVE, LARCHMONT, NY, 10538, US

(21) Appl. No.: 11/726,668

(22) Filed: Mar. 22, 2007

(51) Int. Cl. E06B 9/08

(52) U.S. Cl. 160/23.1

(57) ABSTRACT

An electrically operated remote control apparatus for raising and lowering window shades.

### FIELD OF THE INVENTION

The present invention relates to an electrically operated remote control apparatus for raising and lowering window shades.

### BACKGROUND OF THE INVENTION

There are many known types of electrically operated remote control apparatus for automatically raising and lowering window shades. The present invention is directed toward a new and improved type of such apparatus which can be manufactured at relatively low cost.

### SUMMARY OF THE INVENTION

In accordance with the principles of this invention, an electric adjustable tension shade bar employs a hollow composite elongated rotatable cylinder adjustable in length and having adjustable tension means at each end adapted to detachably engage opposite vertical sides of a window frame.

A direct current motor is disposed in the cylinder. Electric batteries are also disposed in the cylinder.

An electric connector means in the cylinder connects the batteries and the motor. This means is remotely operated by a control unit to connect the batteries to the motor into selected alternative first, second and third positions.

The motor rotates in a first direction in the first position, rotates in the second and opposite direction in the second position, and is rotationless in the third position.

A control unit is disposed outside of the cylinder and is electrically coupled to said connector means.

Gearing means in the cylinder interconnects the motor and the cylinder to cause the cylinder to rotate in the first direction when the motor rotates in the first direction, to rotate in the second direction when the motor rotates in the second direction, and to be rotationless when the motor is in its third position.

An elongated flat member is disposed in the cylinder. While the member is parallel to the axis of the cylinder it is fixed in position and does not rotatable therewith. The member supports the motor, connector means and batteries which are secured in fixed position on the member. A shade can be wrapped around the cylinder and detachably secured thereto.

Additional aspects of the invention will either be explained or will become apparent hereinafter.

### BRIEF DESCRIPTIONS OF THE DRAWINGS

FIG. 1 is a perspective view of one embodiment of the invention.

FIG. 2 is a cross sectional view of the embodiment of FIG. 1.

FIG. 2A is a detailed cylindrical view of the roller bearing and holder notches.

FIG. 2B is a close up view of the sizing apparatus.

FIG. 2C illustrates the relationship between the motor gear and the roller gear.

FIG. 3 is a detail view of the power components.

FIG. 4 is a view of the tightening grip with wrench for a window jamb,

### DETAILED DESCRIPTION OF THE PREFERRED EMBODIMENTS

The electric shade roll of the present invention is shown generally in FIGS. 1, 2, 2A, 2B, 2C, 3 and 3A.

Referring to FIG. 1 a perspective view of the electric shade roll 10 of the present invention is shown to include a male adjusting roller 11 fitting into the female extending roller 12 used to adjust the length of the shade roller 10. On each opposing ends thereof sits a grip for window jamb 13 on one end and the tightening grip for window jamb 14 on the other, both of which contact the window jamb 29. The shade material 17 attaches to the electric shade roll 10 with the provided Velcro 21. Attachment of the shade material 17 will be made at the Velcro strips 21 to provide a means for rolling and unrolling the shade material 17.

FIG. 1 lastly demonstrates the placement of batteries 24 for the ease of battery replacement without the removal of the shade from its installed position.

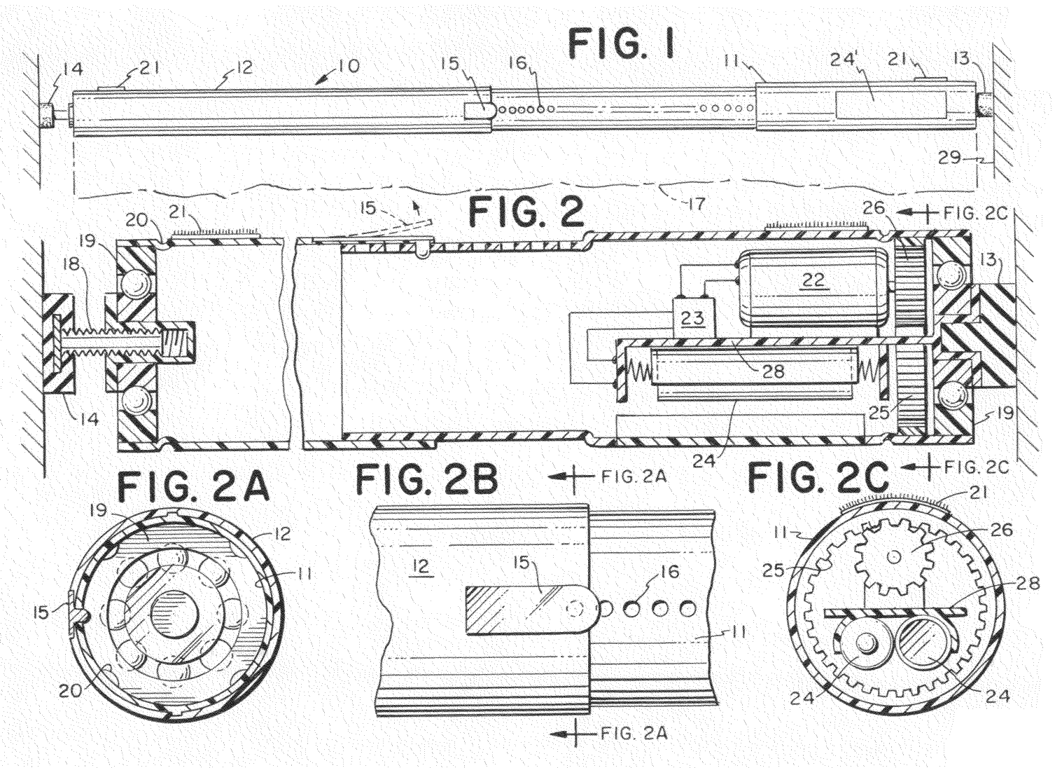

In FIG. 2 a cross sectional view displays the electric shade roll. As described in more detail below the male adjusting roller 11 and female extending roller 12 of the electric shade roller telescope fit relative to one another while still being able to carry shade material 17 as seen in FIG. 1.

Male adjusting roller 11 has a tubular body and is able to extend or contract into the external female extending roller 12. The shade roller 10 is fitted by lengthening the female extending roller 12 by pulling up on the length adjusting clip 15 and locking it into the proper adjusting holes 16 located on the male adjusting roller 11. The tightening grip for window jamb 14 is used to make firm the shade roller 10 once its length has been adjusted by the length adjusting clip 15 and adjusting holes 16. The free rotation of the shade roller 10 is done by roller bearings 19 at each end of the shade roller. Holding notches 20 prevent movement of the roller bearings 19 as well as firming of the end grips 13 and 14.

The motor gear 26 is linked to the roller gear 25. The roller gear 25 is attached to the female extending roller 12. As rotation of the electric motor 22 begins the motor gear 26 causes the roller gear 25 to rotate thereby rotating the attached shade roller 10, and causing the attached shade material 17 to wind or unwind. The attachment plate 28 is parallel to the axis, but extends non-rotatably in fixed position through central openings in gear 25 and bearing 19. This plate provides a stable base for attachment of the motor 22, the batteries 24, and the electric connector means 23. This means contains electrical switches and is remotely operated by a control 30 to connect the batteries to the motor into selected alternative first, second and third positions, the motor rotating in a first direction in the first position, rotating in the second and opposite direction in the second position, and being rotationless in the third position;

Gears 26 and 25 constitute gearing means in the cylinder interconnecting the motor and the cylinder to cause the cylinder to rotate in the first direction when the motor rotates in the first direction, to rotate in the second direction when the motor rotates in the second direction, and to be rotationless when the motor is in its third position.

In FIG. 2A a detailed cylindrical view of how the holding notches 20 hold firm the roller bearing 19. Also shown is how the notch of the length adjusting clip 15 locks the male adjusting roller 11 and the female extending roller 12 in place.

FIG. 2B is a close up view of the length adjusting clip 15 engaging the closely spaced adjusting holes 16.

FIG. 2C shows the relationship of the motor gear 26 and the roller gear 25.

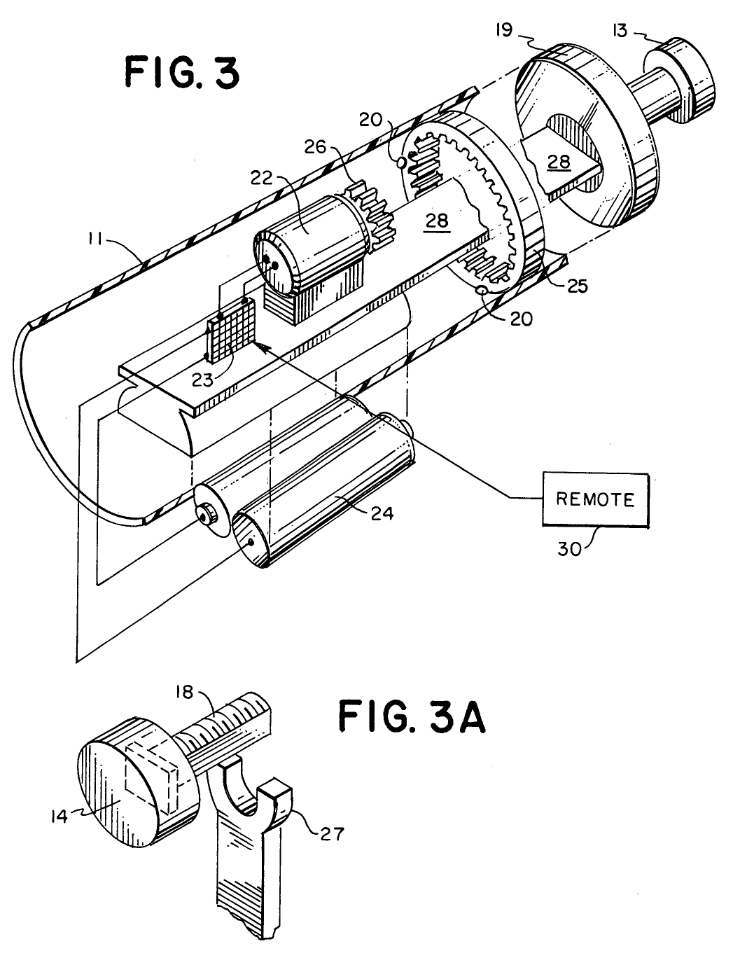

FIG. 3 details the relationship of the power components for the working electric shade roller. The stable grip for window jamb 13 is connected with the attachment plate 28. Surrounding the extremity of the attachment plate 28 is the roller bearing 19 and the roller gear 25 held in place by the holding notch 20. The batteries 24 power the motor 22 and the coordination of this activity is conducted by the means 23 and control 30.

In FIG. 3A a tightening wrench 27 is used on the flat portion of the tightening grip for window jamb 14 to create a holding frictional force on the window jamb 29 by the shade roller 10. The grips 13 and 14 will be easily removable and replaced to provide mounting options for the electric shade roller 10.

While this invention has been described in detail with reference to the drawings and preferred embodiments, the protection solicited is to be limited only by the terms that follow,

What is claimed is:

1. An electric adjustable tension shade bar comprising:
a hollow composite elongated rotatable cylinder adjustable in length and having adjustable tension means at each end adapted to detachably engage opposite vertical sides of a window frame;
a direct current motor disposed in the cylinder;
electric batteries disposed in the cylinder;
an electric connector means in the cylinder connecting the batteries and the motor, said means being remotely operated by a control unit to connect the batteries to the motor into selected alternative first, second and third positions, the motor rotating in a first direction in the first position, rotating in the second and opposite direction in the second position, and being rotationless in the third position;
a control disposed outside of the cylinder and electrically coupled to said connector means;
gearing means in the cylinder interconnecting the motor and the cylinder to cause the cylinder to rotate in the first direction when the motor rotates in the first direction, to rotate in the second direction when the motor rotates in the second direction, and to be rotationless when the motor is in its third position.

2. A bar as set forth in claim 1 further including an elongated flat member disposed in the cylinder and non-rotatably therewith, said member supporting the motor, connector means and batteries which are secured in fixed position on the member.

3. A bar as set forth in claim 2 further including a shade wrapped around the cylinder and detachably secured thereto.

4. A bar as set forth in claim 3 wherein the cylinder is composed of slidably mating cylindrical elements.

5. A bar as set forth in claim 4 wherein the connector means contains electrical switches.

6. A bar as set forth in claim 4 wherein said elements are composed of male and female elements.

7. A bar as set forth in claim 2 wherein said member is parallel to the axis of the cylinder.
